(19) United States
(12) Patent Application Publication
(10) Pub. No.: US 2016/0059847 A1
(43) Pub. Date: Mar. 3, 2016

(54) INCREASED ELECTRIC MACHINE CAPABILITY DURING ENGINE START

(71) Applicant: FORD GLOBAL TECHNOLOGIES, LLC, Dearborn, MI (US)

(72) Inventors: Scott James THOMPSON, Waterford, MI (US); Walter Joseph ORTMANN, Saline, MI (US); Mark Steven YAMAZAKI, Canton, MI (US)

(21) Appl. No.: 14/474,513

(22) Filed: Sep. 2, 2014

(51) Int. Cl. B60W 20/00; B60W 10/08; B60W 10/06

(52) U.S. Cl. CPC B60W 20/40; B60W 10/06; B60W 10/08; B60W 2710/083; Y10S 903/93

(57) ABSTRACT

A powertrain controller for a vehicle may include input channels configured to receive start requests for an engine and operating condition data for an electric machine, and output channels configured to provide torque commands for the electric machine. The powertrain controller may further include control logic configured to, in response to receiving a start request for the electric machine while the operating condition data indicates that the electric machine is operating at a torque limit to drive the vehicle, generate torque commands that cause the electric machine to exceed the torque limit.

### TECHNICAL FIELD

The present disclosure relates to modifying torque limits in hybrid vehicles.

### BACKGROUND

A hybrid electric vehicle utilizes both an engine and an electric machine to provide torque to the wheels. A disconnect clutch may decouple the engine from the vehicle powertrain to allow the engine to be in an off state while the electric machine is propelling the vehicle.

### SUMMARY

A method of controlling a vehicle is provided. The method may include, in response to receiving a start request for an engine while an electric machine is generating torque to drive the vehicle at a torque limit of the electric machine, increasing the torque beyond the torque limit for a predefined duration of time to provide torque to start the engine.

A vehicle is provided. The vehicle includes an engine, a fraction motor, and a controller. The controller may be configured to, in response to receiving a request for additional torque to start the engine while the fraction motor is operating at a torque limit to satisfy a drive torque command, command the traction motor to increase torque output for a predefined duration of time to satisfy the request for additional torque.

A powertrain controller for a vehicle is provided. The controller may include input channels configured to receive start requests for an engine and operating condition data for an electric machine, and output channels configured to provide torque commands for the electric machine. The controller may further include control logic configured to, in response to receiving a start request for the electric machine while the operating condition data indicates that the electric machine is operating at a torque limit to drive the vehicle, generate torque commands that cause the electric machine to exceed the torque limit.

### BRIEF DESCRIPTION OF THE DRAWINGS

FIG. 1 is a schematic diagram of a hybrid electric vehicle;

FIG. 2 is a graph depicting the relationship between torque and speed during operation of a hybrid electric vehicle;

FIGS. 3A through 3C are a series of graphs depicting the relationship between speed, torque, and time during operation of a hybrid electric vehicle; and

FIG. 4 is a flow chart describing control logic for a powertrain controller of a hybrid electric vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

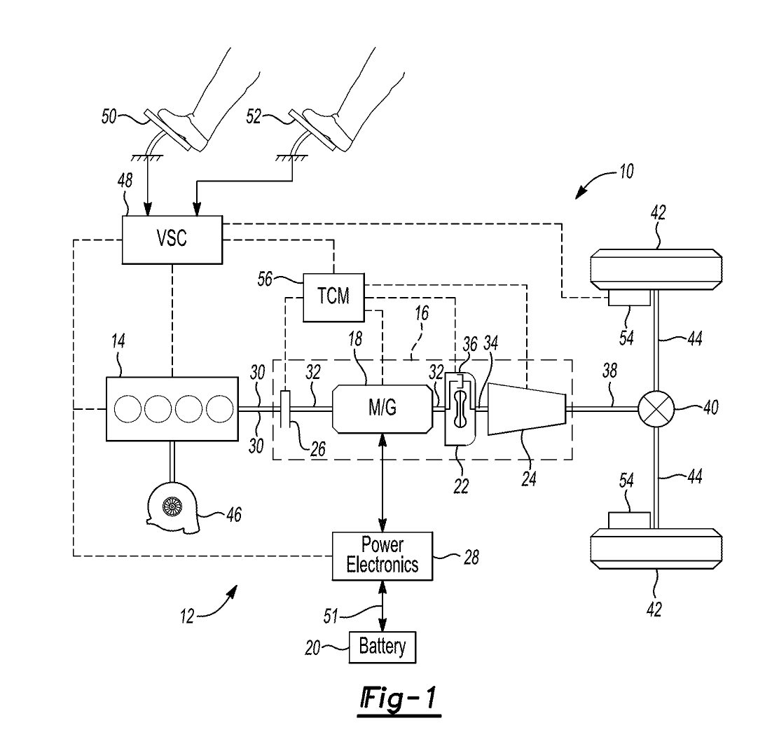

Referring to FIG. 1, a schematic diagram of a hybrid electric vehicle (HEV) 10 is illustrated. FIG. 1 illustrates representative relationships among several vehicle components. Physical placement and orientation of the components within the vehicle 10 may vary. The vehicle 10 includes a powertrain 12. The powertrain 12 includes an engine 14 that drives a transmission 16. As will be described in further detail below, the transmission 16 includes an electric machine such as an electric motor/generator (M/G) 18, an associated traction battery 20, a torque converter 22, and a multiple step-ratio automatic transmission, or gearbox 24.

The engine 14 and the M/G 18 are both capable of providing motive power for the HEV 10. The engine 14 generally represents a power source which may include an internal combustion engine such as a gasoline, diesel, or natural gas powered engine, or a fuel cell. The engine 14 generates an engine power and corresponding engine torque that is supplied to the M/G 18 when a disconnect clutch 26 between the engine 14 and the M/G 18 is at least partially engaged. The M/G 18 may be implemented by any one of a plurality of types of electric machines. For example, the M/G 18 may be a permanent magnet synchronous motor. Power electronics 28 condition direct current (DC) power provided by the battery 20 to the requirements of the M/G 18, as will be described below. For example, power electronics may provide three phase alternating current (AC) to the M/G 18.

The engine 14 may additionally be coupled to a turbocharger 46 to provide an air intake pressure increase, or “boost” to force a higher volume of air into a combustion chamber of the engine 14. Related to the increased air pressure provided to the engine 14 by the turbocharger 46, a corresponding increase in the rate of fuel combustion may be achieved. The additional air pressure boost therefore allows the engine 14 to achieve additional output power, thereby increasing engine torque.

The gearbox 24 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between a transmission output shaft 38 and the transmission input shaft 34. The gearbox 24 ultimately provides a powertrain output torque to output shaft 38.

As further shown in the representative embodiment of FIG. 1, the output shaft 38 is connected to a differential 40. The differential 40 drives a pair of wheels 42 via respective axles 44 connected to the differential 40. The differential transmits torque allocated to each wheel 42 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The vehicle 10 further includes a foundation brake system 54. The system may comprise friction brakes suitable to selectively apply pressure by way of stationary pads attached to a rotor affixed to the wheels. The applied pressure between the pads and rotors creates friction to resist rotation of the vehicle wheels 42, and is thereby capable of slowing the speed of vehicle 10.

When the disconnect clutch 26 is at least partially engaged, power flow from the engine 14 to the M/G 18 or from the M/G 18 to the engine 14 is possible. For example, when the disconnect clutch 26 is engaged, the M/G 18 may operate as a generator to convert rotational energy provided by a crankshaft 30 through M/G shaft 32 into electrical energy to be stored in the battery 20. The rotational resistance imparted on the shaft through regeneration of energy may be used as a brake to decelerate the vehicle. The disconnect clutch 26 can also be disengaged to decouple the engine 14 from the remainder of the powertrain 12 such that the M/G 18 can operate as the sole drive source for the vehicle 10.

Operation states of the powertrain 12 may be dictated by at least one controller. While illustrated by way of example as a single controller, such as a vehicle system controller (VSC) 48, there may be a larger control system including several controllers. The individual controllers, or the control system, may be influenced by various other controllers throughout the vehicle 10. For example controllers that may be included within representation of the VSC 48 include a transmission control module (TCM), brake system control module (BSCM), a high voltage battery energy control module (BECM), as well as other controllers in communication which are responsible for various vehicle functions. The at least one controller can collectively be referred to as a “controller” that commands various actuators in response to signals from various sensors. The VSC 48 response may serve to dictate or influence a number of vehicle functions such as starting/stopping engine 14, operating the M/G 18 to provide wheel torque or recharge the traction battery 20, select or schedule transmission gear shifts, etc.

The VSC 48 may further include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The VSC 48 communicates with various engine/vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, the VSC 48 may communicate signals to and/or from the engine 14, the turbocharger 46, the disconnect clutch 26, the M/G 18, the transmission gearbox 24, torque converter 22, the torque converter bypass clutch 36, and the power electronics 28. Although not explicitly illustrated, those of ordinary skill in the art will recognize various functions or components that may be controlled by the VSC 48 within each of the subsystems identified above. Representative examples of parameters, systems, and/or components that may be directly or indirectly actuated using control logic executed by the controller include fuel injection timing, rate, and duration, throttle valve position, spark plug ignition timing (for spark-ignition engines), intake/exhaust valve timing and duration, front-end accessory drive (FEAD) components such as an alternator, air conditioning compressor, battery charging, regenerative braking, M/G operation, clutch pressures for disconnect clutch 26, torque converter bypass clutch 36, and transmission gearbox 24, and the like. Sensors communicating input through the I/O interface may be used to indicate turbocharger boost pressure, turbocharger rotation speed, crankshaft position, engine rotational speed (RPM), wheel speeds, vehicle speed, engine coolant temperature, intake manifold pressure, accelerator pedal position, ignition switch position, throttle valve position, air temperature, exhaust gas oxygen or other exhaust gas component concentration or presence, intake air flow, transmission gear, ratio, or mode, transmission oil temperature, transmission turbine speed, torque converter bypass clutch status, deceleration, or shift mode, for example.

The VSC 48 also includes a torque control logic feature. The VSC 48 is capable of interpreting driver requests based on several vehicle inputs. These inputs may include, for example, gear selection (PRNDL), accelerator pedal inputs, brake pedal input, battery temperature, voltage, current, and battery state of charge (SOC). The VSC 48 in turn may issue command signals to the transmission to control the operation of the M/G 18.

The M/G 18 is also in connection with the torque converter 22 via shaft 32. Therefore, the torque converter 22 is also connected to the engine 14 when the disconnect clutch 26 is at least partially engaged. The torque converter 22 includes an impeller fixed to the M/G shaft 32 and a turbine fixed to a transmission input shaft 34. The torque converter 22 provides a hydraulic coupling between shaft 32 and transmission input shaft 34. An internal bypass clutch 36 may also be provided such that, when engaged, clutch 36 frictionally or mechanically couples the impeller and the turbine of the torque converter 22, permitting more efficient power transfer. The torque converter bypass clutch 36 may be operated as a launch clutch to provide smooth vehicle launch. In contrast, when the bypass clutch 36 is disengaged, the M/G 18 may be decoupled from the differential 40 and the vehicle axles 44. For example, during deceleration the bypass clutch 36 may disengage at low vehicle speeds, providing a torque bypass, to allow the engine to idle and deliver little or no output torque to drive the wheels.

A driver of the vehicle 10 may provide input at accelerator pedal 50 and create a demanded torque, power, or drive command to propel the vehicle 10. In general, depressing and releasing the pedal 50 generates an accelerator input signal that may be interpreted by the VSC 48 as a demand for increased power or decreased power, respectively. Based at least upon input from the pedal, the controller 48 may allocate torque commands between each of the engine 14 and/or the M/G 18 to satisfy the vehicle torque output demanded by the driver. The controller 48 may also control the timing of gear shifts within the gearbox 24, as well as engagement or disengagement of the disconnect clutch 26 and the torque converter bypass clutch 36. Like the disconnect clutch 26, the torque converter bypass clutch 36 can be modulated across a range between the engaged and disengaged positions. This may produce a variable slip in the torque converter 22 in addition to the variable slip produced by the hydrodynamic coupling between the impeller and the turbine. Alternatively, the torque converter bypass clutch 36 may be operated as either locked or open without using a modulated operating mode depending on the particular application.

The driver of vehicle 10 may additionally provide input at brake pedal 52 to create a vehicle braking demand. Depressing brake pedal 52 generates a braking input signal that is interpreted by controller 48 as a command to decelerate the vehicle. The controller 48 may in turn issue commands to cause the application of negative torque to the powertrain output shaft. Additionally or in combination, the controller may issue commands to activate the brake system 54 to apply friction brake resistance to inhibit rotation of the vehicle wheels 42. The negative torque values provided by both of the powertrain and the friction brakes may be allocated to vary the amount by which each satisfies driver braking demand.

To drive the vehicle with the engine 14, the disconnect clutch 26 is at least partially engaged to transfer at least a portion of the engine torque through the disconnect clutch 26 to the M/G 18, and then from the M/G 18 through the torque converter 22 and gearbox 24. The M/G 18 may assist the engine 14 by providing additional powered torque to turn the shaft 32. This operation mode may be referred to as a “hybrid mode.” As mentioned above, the VSC 48 may be further operable to issue commands to allocate a torque output of both the engine 14 and the M/G 18 such that the combination of both torque outputs satisfies an accelerator 50 input from the driver.

To drive the vehicle 10 with the M/G 18 as the sole power source, the power flow remains the same except the disconnect clutch 26 isolates the engine 14 from the remainder of the powertrain 12. Combustion in the engine 14 may be disabled or otherwise OFF during this time in order to conserve fuel, for example. The traction battery 20 transmits stored electrical energy through wiring 51 to power electronics 28 that may include an inverter. The power electronics 28 convert high-voltage direct current from the battery 20 into alternating current for use by the M/G 18. The VSC 48 may further issue commands to the power electronics 28 such that the M/G 18 is enabled to provide positive or negative torque to the shaft 32. This operation where the M/G 18 is the sole motive source may be referred to as an “electric only” operation mode.

Therefore, it may be advantageous to operate the vehicle 10 in the “electric only” operation mode. However, during an engine restart command from the VSC 48, drive torque from the M/G 18 may be reduced in order to supply the necessary engine torque to restart the vehicle engine 14. In at least one embodiment, the VSC 48 may be programmed to increase torque output by the M/G 18 such that the torque output exceeds a drive torque limit of the M/G 18 to provide start torque for the engine 14. This allows for an extended “electric only” operation mode.

Additionally, the M/G 18 may operate as a generator to convert kinetic energy from the powertrain 12 into electric energy to be stored in the battery 20. The M/G 18 may act as a generator while the engine 14 is providing the sole propulsion power for the vehicle 10, for example. The M/G 18 may also act as a generator during times of regenerative braking in which rotational energy from spinning of the output shaft 38 is transferred back through the gearbox 24 and is converted into electrical energy for storage in the battery 20.

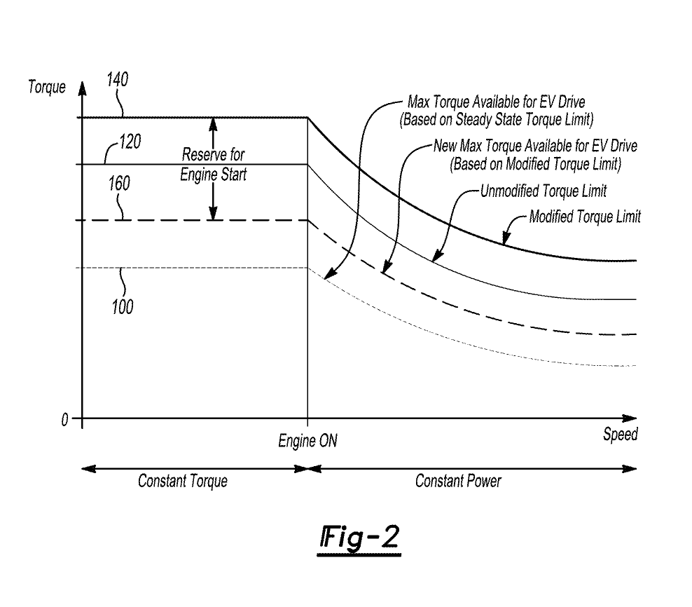

FIG. 2 is a graph of an increased torque output by the M/G 18. FIG. 2 shows torque in Nm increasing along the y-axis and speed in RPM increasing along the x-axis. FIG. 2 depicts curves for periods of constant torque and constant power. Modifying a drive torque limit of the M/G 18 allows the M/G 18 to briefly output torque above a maximum drive torque limit. Curve 100 represents an unmodified drive torque limit for drive torque generated by the M/G 18. The unmodified drive torque limit, as represented by curve 100, may be a generally conservative maximum drive torque limit. The maximum drive torque limit of the M/G 18 is based on the basic design of the M/G 18. Likewise, curve 120 represents a maximum drive torque availability for “electric only” operation mode. Curve 120 is representative of the unmodified drive torque limit of curve 100 minus an engine start torque reserved for engine starts or restarts. As depicted by curve 120, this minimizes the availability of drive torque from the M/G 18 used during “electric only” operation mode. Increasing the maximum drive torque available during “electric only” operation mode without increasing the size of the M/G 18 improves overall fuel economy.

Curve 140 represents a modified drive torque limit for drive torque generated by the M/G 18. Because the unmodified drive torque limit, as represented by curve 100, is generally conservative, a modified drive torque limit, as represented by curve 140, may be used that accounts for transient bursts of required drive torque. For example, the modified drive torque limit represented by curve 140, may be used for engine starts and restarts that occur in less than one second. Likewise, curve 160 represents a new maximum drive torque availability for “electric only” operation mode. This is based on the modified drive torque limit, as represented by curve 140. The new maximum drive torque availability, as represented by curve 160, equals the modified torque limit, as represented by curve 140, minus the torque reserved for engine starts and restarts. By increasing the unmodified, steady-state maximum torque limit of curve 100 to account for short transient bursts of required drive torque, more drive torque is available for operation within the “electric only” operation mode. This allows the M/G 18 to provide the sole motive power for a longer duration. Extending the range of the “electric only” operation mode allows for significant improvement in vehicle fuel economy.

The modified drive torque limit, as represented by curve 140, acts as a buffer accounting for engine starts and restarts. The amount of torque required for engine starts and restarts may be pre-calculated. Therefore, the steady-state drive torque limit, as represented by curve 100, may be raised by the pre-calculated torque necessary for engine starts and restarts for short durations. This allows for improved “electric only” operation mode capability. Further, this increases the engine off capability. Increasing the engine off capability offers the flexibility to utilize different engine brake specific fuel consumption maps. Improving the “electric only” operation mode capability and increasing the engine off capability improves fuel economy over a wide range of operating conditions.

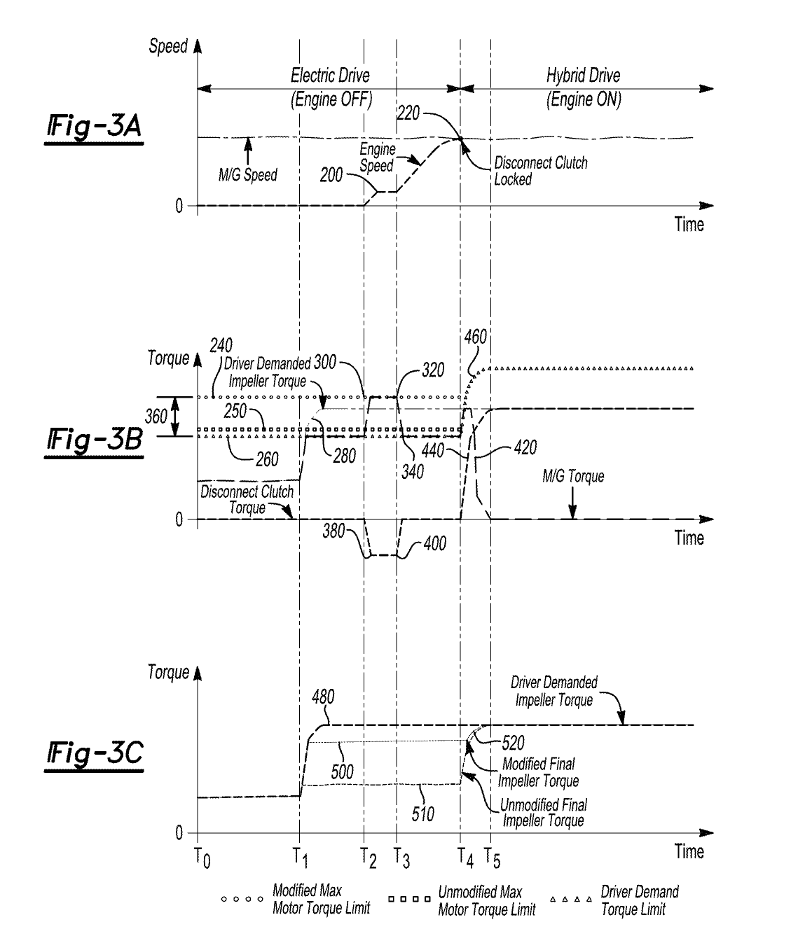

FIGS. 3A through 3C are a series of graphs depicting the modified drive torque limit during “electric only” operation mode and “hybrid mode.” The graphs measure three different curvatures over a period of five different time intervals. The first graph measures the M/G speed and the engine speed increasing along the y-axis with the time intervals extending along the x-axis. The second graph measures M/G drive torque, engine torque, and disconnect clutch torque increasing along the y-axis with the time intervals extending along the x-axis. The third graph measures the engine torque increasing along the y-axis with the time intervals extending along the x-axis.

The first graph, referenced as graph A, measures the M/G speed as well as the engine speed over time. Specifically, the first graph compares the behavior of the M/G speed and the engine speed during the “electric only” operation mode and the “hybrid mode.” As noted in the first graph, engine speed reaches peak 200 between T₂ and T₃. As discussed in more detail below, this peak is consistent with an engine start or restart command due to an accelerator pedal tip-in event. Further, from time interval T₃ through T₄, the engine speed ramps up reaching peak 220 at T₄. Peak 220 represents the point at which the disconnect clutch 26 is locked and the engine speed matches the M/G speed. Therefore, from time interval T₄ through T₅, the engine 14 will be supplying engine torque along with the M/G 18 providing drive torque. When the engine 14 is on, the vehicle 10 will be in the “hybrid mode” operation.

The second graph, referenced as graph B, depicts torque increasing along the y-axis and time increasing along the x-axis. Dashed line 240 represents the maximum motor torque limit, as modified, to account for a transient burst of demanded torque during engine starts and restarts. Dashed line 260 represents the torque available during “electric only” operation mode. Using the modified maximum torque limit, as represented by line 240, allows for much more M/G drive torque available during “electric only” operation mode. For example, as a vehicle driver demands impeller torque from the engine at peak 280 between time intervals T₁ and T₂, the modified maximum motor torque limit allows the M/G 18 to provide the impeller torque demand.

Dashed line 250 represents the unmodified maximum motor torque limit. As stated above, the unmodified maximum motor torque is a generally conservative limit. This allows the M/G 18 to ramp up to the modified maximum torque limit, as represented by line 240, for transient bursts during an engine start request. By increasing the unmodified maximum motor torque limit of line 250 to the modified maximum torque limit of line 240, the vehicle is able to operate in “electric only” operation mode for a longer period of time.

During time interval T₂ and T₃ the M/G torque will be increased, between peaks 300 and 320, up to the modified maximum torque limit. The M/G 18 will continue to provide drive torque at the modified maximum torque limit through a relatively small time interval. For example, in order to account for the torque demanded for engine starts and restarts, the M/G 18 will continue to provide drive torque at the modified maximum torque limit for approximately one second. Likewise, during time intervals T₂ and T₃ the disconnect clutch torque may have a complementary curvature as the M/G torque, as described above. The disconnect clutch torque will decrease by the amount of torque demanded from the modified maximum motor torque limit between peaks 380 and 400. The disconnect clutch torque decreases due to pressure applied to the disconnect clutch in order to account for the engine start command. The additional torque load from the engine drags the disconnect clutch torque negative. This is consistent with a partially closed position of the disconnect clutch. The M/G 18 compensates for the negative torque of the disconnect clutch by applying increased positive torque. This allows the net transmission input shaft torque to remain constant. Between time intervals T₃ and T₄ the M/G 18 will ramp down at 340 and continue to provide drive torque at the maximum torque availability limit represented by dashed line 260.

Utilizing the modified maximum torque limit to account for an increase torque demand event, such as an engine start or restart, allows for a torque buffer 360. This allows much more drive torque available from the M/G 18 during “electric only” operation mode. Having more drive torque allows for an improved electric drive capability and improves fuel economy over a wide range of operating conditions. Further, since the additional torque is only provided within a relatively small time interval, there is little impact on the lifespan or functionality of the M/G 18.

As the vehicle 10 begins to enter “hybrid mode” operation, between time intervals T₄ and T₅, the drive torque produced by the M/G 18 will ramp down slope 420. As discussed above, when the vehicle is in the “hybrid” drive mode the engine 14 is providing engine torque to the powertrain 12. When the engine 14 is providing engine torque to the powertrain 12, the drive torque produced by the M/G 18 will reduce to zero. Likewise, the torque produced by the disconnect clutch 26 will ramp up slope 440 until it meets the driver demanded impeller torque from the engine 14. Slope 440 represents a slipping condition of the disconnect clutch. The slipping condition of the disconnect clutch occurs when the turbine shaft is rotating at a faster rate than the impeller shaft. Therefore, the disconnect clutch will be in a locked condition after time interval T₅, when the impeller shaft speed of rotation meets the turbine shaft speed of rotation. This couples the engine 14 to the powertrain 12. This increases the driver demanded torque limit at curve 460 between time intervals T₄ and T₅. This further allows the engine 14 to have a higher driver demand torque limit and produce more output torque.

The third graph, referenced as graph C, depicts torque increasing along the y-axis and time extending along the x-axis. Line 480 depicts driver demanded impeller torque consistent with an engine start and restart event between time interval T₁ and T₅. Line 500 represents the modified final delivered impeller torque between time interval T₁ and T₅. As the engine starts or restarts and the vehicle begins to enter “hybrid” drive operation mode, the final delivered impeller torque peaks at 520 before reaching the demanded impeller torque. Line 510 represents the unmodified final delivered impeller torque between time interval T₁ and T₅. Line 510 shows the final delivered impeller toque using the unmodified maximum motor torque limit. Comparing lines 500 and 510 shows the availability of more torque during “electric only” operation mode. Therefore using the modified maximum M/G torque limit, as discussed above, allows for increased capability within the “electric only” operation mode.

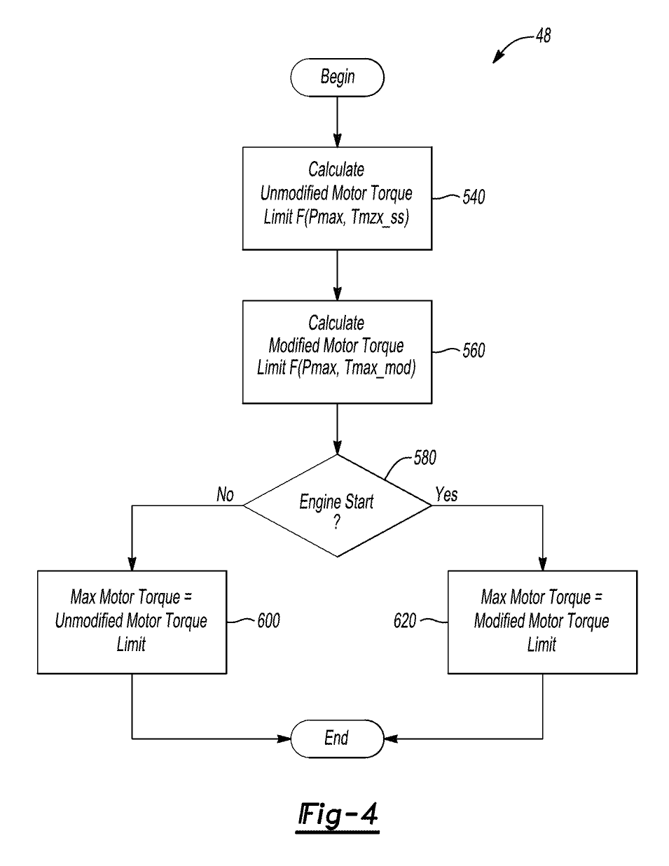

Referring to FIG. 4, a flowchart depicting the control logic of the VSC 48 is shown. At 540, the VSC 48 calculates the unmodified maximum drive torque limit. At 560, the VSC 48 calculates the required drive torque from the M/G 18 necessary for an engine start or restart event. The VSC 48 adds the required drive torque for an engine start at 560 to the unmodified maximum drive torque limit calculated at 540. This allows for a modified maximum drive torque limit at 560. At 580, the VSC 48 determines if an engine start or restart request has been made. If, at 580, the VSC 48 determines that an engine start or restart request has not been made, then at 600 the VSC 48 may command the vehicle to drive during “electric only” operation mode using the unmodified maximum drive torque limit calculated at 540.

Likewise, if at 580, the VSC 48 determines that an engine start or restart request has been made, then at 620 the VSC 48 may command the vehicle to drive during “electric only” operation mode using the modified maximum drive torque limit. This allows the VSC 48 to account for the extra output torque needed in order to start or restart the vehicle engine 14 as the vehicle exits the “electric only” operation mode. Further, the VSC 48 may only command, at 600, operation at the modified maximum torque limit for a short duration. Operating at the modified maximum torque limit for a short duration allows the VSC 48 to account for the added torque necessary for engine start or restart requests without modifying the M/G 18. This allows for an improved fuel economy over a wide range of operating conditions as well as an improved “electric only” operation mode capability.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method of controlling a vehicle comprising:
in response to receiving a start request for an engine while an electric machine is generating torque to drive the vehicle at a torque limit of the electric machine, increasing the torque beyond the torque limit for a predefined duration of time to provide torque to start the engine.

2. The method of claim 1, wherein the predefined duration of time is less than a duration of time to start the engine.

3. The method of claim 2, wherein the predefined duration of time is less than 1.5 seconds.

4. The method of claim 1, further comprising permitting current from a battery powering the electric machine to exceed a discharge limit during the predefined duration of time.

5. The method of claim 1, further comprising in response to the start request, commanding the electric machine to provide a total torque greater than the torque limit.

6. A vehicle comprising:
an engine;
a traction motor; and
a controller configured to, in response to receiving a request for additional torque to start the engine while the traction motor is operating at a torque limit to satisfy a drive torque command, command the traction motor to increase torque output for a predefined duration of time to satisfy the request for additional torque.

7. The vehicle of claim 6, wherein the additional torque is equal to a start torque for the engine.

8. The vehicle of claim 6, wherein the predefined duration of time is less than a duration of time to start the engine.

9. The vehicle of claim 8, wherein the predefined duration of time is approximately 1 second.

10. The vehicle of claim 6, further comprising a traction battery configured to power the traction motor, wherein the controller is further configured to, in response to receiving the request, command current from the fraction battery at a magnitude exceeding a discharge limit of the traction battery.

11. A powertrain controller for a vehicle comprising:
input channels configured to receive start requests for an engine and operating condition data for an electric machine;
output channels configured to provide torque commands for the electric machine; and
control logic configured to, in response to receiving a start request for the electric machine while the operating condition data indicates that the electric machine is operating at a torque limit to drive the vehicle, generate torque commands that cause the electric machine to exceed the torque limit.

12. The controller of claim 11, wherein the generated torque commands cause the electric machine to exceed the torque limit for a predefined duration of time less than a duration of time to start the engine.

13. The controller of claim 12, wherein the predefined duration of time is approximately 1 second.

14. The controller of claim 11, wherein the output channels are further configured to provide current commands for a fraction battery configured to power the electric machine and wherein the control logic is further configured to, in response to receiving the start request, generate current commands that cause the traction battery to exceed a discharge limit during the predefined duration of time.
